(19) United States
(12) Patent Application Publication
(10) Pub. No.: US 2026/0023881 A1
(43) Pub. Date: Jan. 22, 2026

(54) Information Processing Method, Non-Transitory Computer-Readable Storage Medium, and Information Processing Apparatus

(71) Applicant: SocialGood, Inc., Chiyoda-ku, Tokyo (JP)

(72) Inventor: Soichiro Takaoka, Chiyoda-ku, Tokyo (JP)

(21) Appl. No.: 18/871,951

(22) PCT Filed: Jun. 14, 2023
(86) PCT No.: PCT/JP2023/021994

§ 371 Date: Dec. 5, 2024

(30) Foreign Application Priority Data
Jul. 14, 2022 (JP) 2022-113336

(51) Int. Cl. G06F 21/62; G06Q 20/38

(52) U.S. Cl. CPC G06F 21/629; G06Q 20/389

(57) ABSTRACT

There is provided an information processing method in which a computer executes processing of: determining whether or not the amount of cryptocurrency held by a user is less than a predetermined number; and restricting the user's use of an application or service when it is determined that the amount held is less than the predetermined number. Preferably, the amount of cryptocurrency held by the user is acquired based on the user's wallet address.

### CROSS-REFERENCE TO RELATED APPLICATIONS

This application is the national phase under 35 U. S. C. § 371 of PCT International Application No. PCT/JP2023/021994 which has an International filing date of Jun. 14, 2023 and designated the United States of America.

### FIELD

The present invention relates to an information processing method, a non-transitory computer-readable storage medium, and an information processing apparatus.

### BACKGROUND

There are techniques for restricting the use of application programs (hereinafter, referred to as “applications”) and the like.

For example, Japanese Patent Laid-Open Publication No. 2021-157823 discloses a method for restricting the use of an application, in which usage conditions including the time, geographical location, network conditions, and user attributes of a mobile terminal are set in advance and the use of the application is restricted when the operating environment of the mobile terminal satisfies the usage conditions.

### Citation List

### SUMMARY

However, the invention of Japanese Patent Laid-Open Publication No. 2021-157823 does not make use of cryptocurrency.

In one aspect, an object thereof is to provide an information processing method and the like that can restrict the use of an application and the like by utilizing cryptocurrency.

In one aspect, there is provided an information processing method in which a computer executes processing of: determining whether or not an amount of cryptocurrency held by a user is less than a predetermined number; and restricting the user's use of an application or service when it is determined that the amount held is less than the predetermined number.

In one aspect, it is possible to restrict the use of an application and the like by utilizing cryptocurrency.

The above and further objects and features will more fully be apparent from the following detailed description with accompanying drawings.

### BRIEF DESCRIPTION OF THE DRAWINGS

FIG. 1 is a schematic diagram showing an example of the configuration of an information processing system.

FIG. 2 is a block diagram showing an example of the configuration of a server.

FIG. 3 is an explanatory diagram showing an example of a record layout of a user DB.

FIG. 4 is a block diagram showing an example of the configuration of a terminal.

FIG. 5 is an explanatory diagram showing an overview of Embodiment 1.

FIG. 6 is an explanatory diagram showing an example of a pop-up screen.

FIG. 7 is a flowchart showing an example of the procedure of processing executed by a server.

FIG. 8 is a flowchart showing an example of the procedure of processing executed by a server according to Embodiment 2.

### DETAILED DESCRIPTION

Hereinafter, the present disclosure will be described in detail with reference to the diagrams showing embodiments thereof.

### Embodiment 1

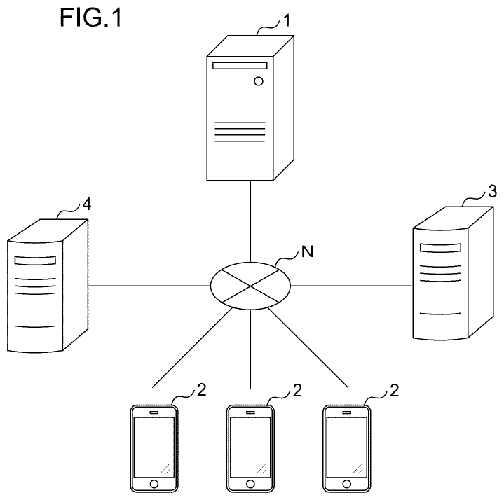

FIG. 1 is a schematic diagram showing an example of the configuration of an information processing system. In the present embodiment, an information processing system that restricts the use of an application or service (hereinafter, referred to as “application and the like”) when a user does not hold a predetermined number of cryptocurrency tokens (hereinafter, referred to as “tokens”) or more. The information processing system includes an information processing apparatus 1, terminals 2, 2, 2, . . . , an exchange server 3, and an issuing server 4. The apparatuses are communicatively connected to each other through a network N such as the Internet.

The information processing apparatus 1 is an information processing apparatus capable of performing various kinds of information processing and transmitting and receiving information, and is, for example, a server computer or a personal computer. In the present embodiment, the information processing apparatus 1 is assumed to be a server computer, and will be read as a server 1 below for the sake of simplicity. The server 1 is a server computer of an administrator of this system that provides a user with an application and the like, and the present embodiment will be described as providing a predetermined application.

As will be described later, when a user does not hold a predetermined number of tokens or more unique to this system, the server 1 restricts the operation of the application. That is, the server 1 makes the token function as membership for using the application. By setting holding a predetermined number of tokens or more as a condition for membership, it is possible to increase demand for tokens, that is, cryptocurrency, and accordingly, to increase their prices.

In addition, various applications and the like, such as an EC (Electronic Commerce) site, a music application, a video posting site, and an SNS (Social Networking Service) application can be considered, but the content is not particularly limited. In addition, in the present embodiment, tokens are unique to this system, but may be existing cryptocurrency such as Bitcoin (registered trademark) or altcoin.

The terminal 2 is a user terminal used by the user of this system. For example, the terminal 2 is a smartphone, a personal computer, or a tablet terminal. The application provided by the server 1 is installed on the terminal 2 in advance, and the terminal 2 executes the application.

The exchange server 3 is a server computer that functions as a cryptocurrency exchange. The exchange allows the purchase, trading, and the like of cryptocurrency, and users can purchase tokens related to this system at the exchange.

The issuing server 4 is a server computer that issues tokens related to this system. The issuing server 4 issues tokens up to a predetermined upper limit of issuance. The issuing server 4 supplies the issued tokens to the market (exchange) to distribute the tokens.

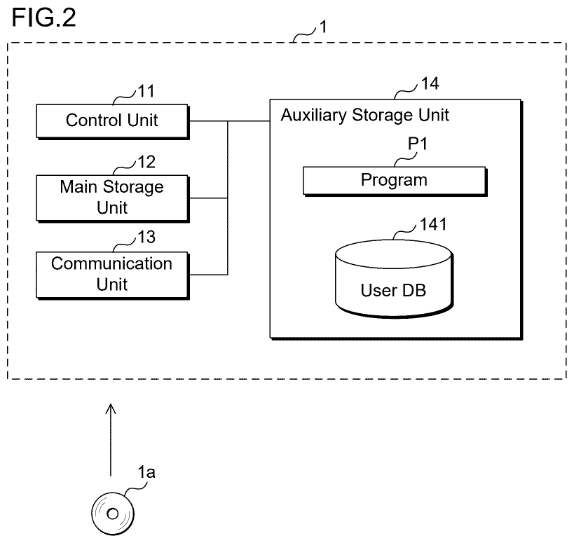

FIG. 2 is a block diagram showing an example of the configuration of the server 1. The server 1 includes a control unit 11, a main storage unit 12, a communication unit 13, and an auxiliary storage unit 14.

The control unit 11 has one or more arithmetic processing devices, such as a CPU (Central Processing Unit), an MPU (Micro-Processing Unit), and a GPU (Graphics Processing Unit), and performs various kinds of information processing, control processing, and the like by reading and executing a program P1 stored in the auxiliary storage unit 14. The main storage unit 12 is a temporary storage area, such as an SRAM (Static Random Access Memory), a DRAM (Dynamic Random Access Memory), and a flash memory, and temporarily stores data required for the control unit 11 to execute arithmetic processing. The communication unit 13 is a communication module for performing processing related to communication, and transmits and receives information to and from the outside.

The auxiliary storage unit 14 is a non-volatile storage area, such as a large-capacity memory and a hard disk, and stores the program P1 (program product) and other kinds of data required for the control unit 11 to execute processing. In addition, the auxiliary storage unit 14 stores a user DB 141. The user DB 141 is a database that stores information about each user.

In addition, the auxiliary storage unit 14 may be an external storage device connected to the server 1. In addition, the server 1 may be a multi-computer formed by a plurality of computers, or may be a virtual machine that is virtually constructed by software.

In addition, in the present embodiment, the server 1 is not limited to the above configuration, and may include, for example, an input unit that receives an operational input, a display unit that displays images, and the like. In addition, the server 1 may include a reading unit for reading a portable storage medium la, such as a CD (Compact Disk)-ROM or a DVD (Digital Versatile Disc)-ROM, so that the program Pl is read from the portable storage medium la and executed.

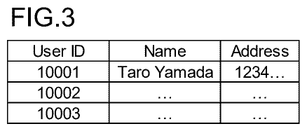

FIG. 3 is an explanatory diagram showing an example of a record layout of the user DB 141. The user DB 141 includes a user ID column, a name column, and an address column. The user ID column stores a user ID for identifying each user. The name column and the address column store the user's name and the user's wallet address, respectively, in association with the user ID.

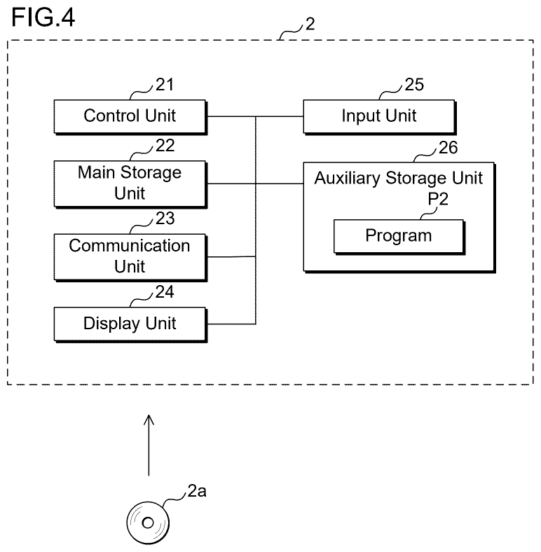

FIG. 4 is a block diagram showing an example of the configuration of the terminal 2. The terminal 2 includes a control unit 21, a main storage unit 22, a communication unit 23, a display unit 24, an input unit 25, and an auxiliary storage unit 26.

The control unit 21 is one or more arithmetic processing devices, such as a CPU and an MPU, and performs various kinds of information processing by reading and executing a program P2 stored in the auxiliary storage unit 26. In addition, the main storage unit 22 is a temporary storage area, such as a RAM, and temporarily stores data required for the control unit 21 to execute arithmetic processing. The communication unit 23 is a communication module for performing processing related to communication, and transmits and receives information to and from the outside. The display unit 24 is a display screen such as a liquid crystal display, and displays images. The input unit 25 is an operation interface, such as a touch panel, and receives an operation input from the user. The auxiliary storage unit 26 is a non-volatile storage area, such as a hard disk or a large-capacity memory, and stores the program P2 (program product) and other kinds of data required for the control unit 21 to execute processing.

In addition, the terminal 2 may include a reading unit for reading a portable storage medium 2a, such as a CD-ROM, so that the program P2 is read from the portable storage medium 2a and executed.

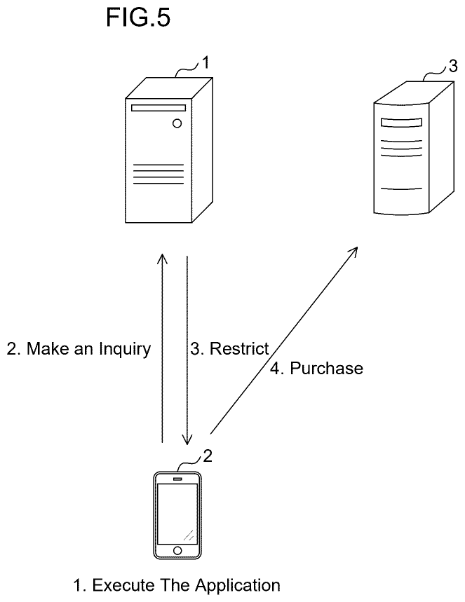

FIG. 5 is an explanatory diagram showing an overview of Embodiment 1. The overview of the present embodiment will be described with reference to FIG. 5.

As already described, in the present embodiment, tokens function as membership for application use. Specifically, when the terminal 2 attempts to execute a main function of an application, the server 1 determines whether or not the amount of tokens held by the user is less than a predetermined number. The main function of an application is, for example, a music playback function in a music application, but the function varies depending on the content of the application.

When executing the main function of the application, the terminal 2 makes an inquiry to the server 1. When the inquiry is received, the server 1 acquires the amount of tokens held by the user. Specifically, the server 1 reads the user's wallet address stored in the user DB 141 in advance, and acquires the amount of tokens held by the user from the blockchain (not shown) based on the wallet address.

In addition, although it is assumed that the amount of tokens held by the user is acquired based on the wallet address in the present embodiment, the present embodiment is not limited thereto. For example, the server 1 may access the exchange (exchange server 3) used by the user to acquire the amount of tokens held by the user. Thus, the server 1 only needs to be able to acquire the amount of tokens, and there is no particular restriction on the acquisition route.

In addition, although it is assumed that the amount of tokens held by the user is passively checked when an inquiry is received from the user terminal in the present embodiment, the present embodiment is not limited thereto, and the amount of tokens held by the user may be automatically checked periodically.

The server 1 determines whether or not the amount of acquired tokens held is less than a predetermined number. In addition, the “predetermined number” used as a criterion for determination may be a fixed number based on tokens, or may be a number that represents a fixed amount when the tokens are converted into legal currency. When it is determined that the amount of tokens held is not less than the predetermined number, the server 1 allows the execution of the main function of the application. On the other hand, when it is determined that the amount of tokens held is less than the predetermined number, the server 1 restricts the use of the application. “Restricting the use of an application” means, for example, stopping the main function of the application, but may be in the form of imposing a restriction on the number of times or the time of the execution of the main function.

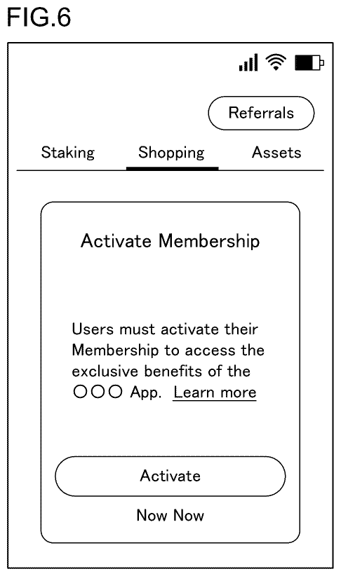

FIG. 6 is an explanatory diagram showing an example of a pop-up screen. When the use of an application is restricted, for example, terminal 2 displays a pop-up screen shown in FIG. 6. This screen is a screen for notifying the user that tokens should be purchased. When an operation input to the “Activate” button on the screen of FIG. 6 is received, the terminal 2 transitions to a screen not shown in the diagram to display an access page to the exchange. The user accesses the exchange from the page and purchases the shortage of tokens. As a result, the user obtains membership.

As described above, according to the present embodiment, when the amount of tokens held is less than a predetermined number, the use of an application and the like is restricted. This increases demand for tokens, which can lead to an increase in their price. In addition, since only users who have a predetermined number of tokens or more can execute the application and the like, the processing load on the server 1 can be reduced.

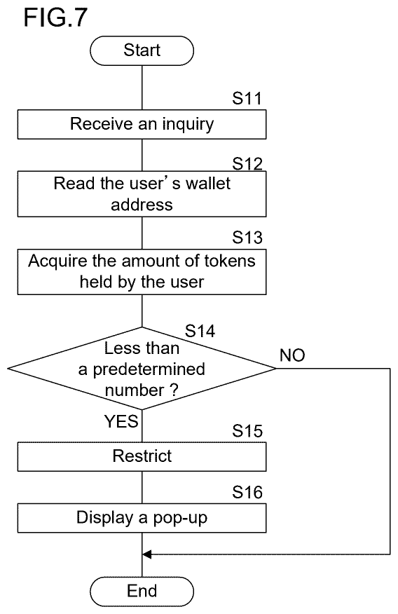

FIG. 7 is a flowchart showing an example of the procedure of processing executed by the server 1. The content of the processing executed by the server 1 will be described with reference to FIG. 7.

The control unit 11 of the server 1 receives an inquiry from the terminal 2 (step S11). When the inquiry is received, the control unit 11 reads the user's wallet address from the user DB 141 (step S12). The control unit 11 acquires the amount of tokens (cryptocurrency) held by the user based on the wallet address (step S13).

The control unit 11 determines whether or not the amount of tokens held by the user is less than a predetermined number (step S14). When it is determined that the amount of tokens held by the user is not less than the predetermined number (S14: NO), the control unit 11 ends the series of processes. When it is determined that the amount of tokens held by the user is less than the predetermined number (S14: YES), the control unit 11 restricts the user from using the application (step

S15). The control unit 11 causes the terminal 2 to display a pop-up (notification) indicating that tokens should be purchased (step S16), and ends the series of processes.

In addition, in the above description, the function of an application and the like provided by the server 1, that is, the administrator of this system, is restricted, but the present embodiment is not limited thereto. That is, the server 1 may be configured to restrict the use of an application and the like provided by a third party other than the administrator of this system. In this case as well, similarly to the above, when an inquiry is received from the user's terminal 2, the server 1 determines whether or not the amount of tokens held by the user is less than a predetermined number, and restricts the use of the application and the like according to the determination result. Thus, the application and the like subject to the restriction may be an application and the like of the third party.

In addition, in the above description, the use of an application and the like is enabled when the amount of tokens held is equal to or greater than the predetermined number, but the present embodiment is not limited thereto. For example, when a user pays a predetermined amount of tokens (or legal currency) per predetermined period to the provider of the application and the like in a subscription format, the application and the like may be made available for use for the predetermined period.

As described above, according to Embodiment 1, it is possible to restrict the use of an application and the like by utilizing cryptocurrency.

### Embodiment 2

In the present embodiment, a form will be described in which the use of an application and the like is restricted in stages according to the amount of tokens held. In addition, the same contents as in Embodiment 1 are denoted by the same reference numerals, and the description thereof will be omitted.

First, an overview of the present embodiment will be described. Here, it is assumed that the standard amount of tokens for restricting the use of an application and the like is 200. That is, the server 1 restricts the use of the application and the like when the amount of tokens held by the user is less than 200.

Here, in the present embodiment, when the amount of tokens is less than 200, the use of the application and the like is not uniformly restricted, but restrictions are imposed in stages according to the amount of tokens held by the user. For example, the server 1 imposes a restriction in units of 50 tokens. That is, when the amount of tokens held is equal to or greater than 150 and less than 200, the server 1 restricts a first function (for example, music playback in the case of a music playback application). Then, when the amount of tokens held is equal to or greater than 100 and less than 150, the server 1 restricts a second function (for example, downloading music). In this manner, the server 1 imposes restrictions in stages.

In addition, for example, the terminal 2 may display functions that the user can use and functions that the user cannot use depending on the amount of tokens held by the user.

In this manner, it is possible to grant membership more preferably by imposing restrictions in stages.

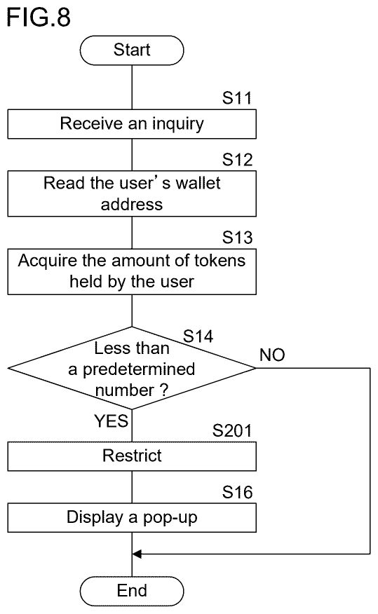

FIG. 8 is a flowchart illustrating an example of the procedure of processing performed by the server 1 according to Embodiment 2. When it is determined that the amount of tokens held by the user is less than a predetermined number (S14: YES), the server 1 executes the following processing.

The control unit 11 of the server 1 restricts the use of the application in stages according to the amount of tokens held by the user (step S201). Specifically, as described above, the control unit 11 increases the number of restricted application functions in stages as the amount of tokens held by the user decreases. The control unit 11 proceeds to step S16.

As described above, according to Embodiment 2, it is possible to grant membership more appropriately by imposing restrictions in stages.

### Modification Example 1

In Embodiment 1, whether or not to restrict the use of an application is determined based on the amount of tokens held by the user. On the other hand, a period during which the user holds tokens may also be taken into consideration when determining whether or not to restrict the use of an application.

For example, the server 1 determines whether or not the amount of tokens held is less than a predetermined number and the holding period is less than a predetermined period. When it is determined that the amount of tokens held is less than the predetermined number and the holding period is less than the predetermined period, the server 1 restricts the use of the application.

In addition, for example, the terminal 2 may display the amount of tokens in shortfall and the holding period according to the amount of tokens held by the user.

Since this creates an incentive for the user to hold on to his or her tokens, it is possible to further increase demand for tokens.

### Modification Example 2

In Embodiment 1, the threshold value (predetermined number) to be compared with the amount of tokens held by the user has been described as a fixed value. On the other hand, the threshold value may be variable.

For example, the server 1 changes the threshold value according to the market price of the token. Specifically, the server 1 acquires market information indicating the market price of the token from the exchange server 3, and changes the above-described predetermined value serving as a threshold value based on the market price.

In this manner, for example, it is possible to reduce the threshold value when the token value rises, so that the amount of tokens required for membership remains unchanged.

### Modification Example 3

In Embodiment 1, a form of restricting the use of an application based on the amount of one kind of token (cryptocurrency) held has been described. On the other hand, the server 1 may restrict the use of an application based on the amount of a plurality of kinds of tokens held.

Specifically, the server 1 determines whether or not the total amount of a plurality of tokens held is less than a predetermined number. When it is determined that the total amount of a plurality of tokens held is less than the predetermined number, the server 1 restricts the user from using the application.

In this manner, the user can configure membership for a plurality of kinds of tokens, so that it is possible to reduce the risk when any one token crashes.

It is to be noted that, as used herein and in the appended claims, the singular forms “a”, “an”, and “the” include plural referents unless the context clearly dictates otherwise.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-8. (canceled)

9. An information processing method in which a computer executes processing of:
determining whether or not an amount of cryptocurrency held by a user is less than a predetermined number; and
restricting the user's use of an application or service when it is determined that the amount held is less than the predetermined number.

10. The information processing method according to claim 9, wherein the computer executes processing of acquiring the amount of cryptocurrency held by the user based on a wallet address of the user.

11. The information processing method according to claim 9, wherein the computer executes processing of acquiring the amount of cryptocurrency held by the user from an exchange used by the user.

12. The information processing method according to claim 9, wherein the cryptocurrency is a cryptocurrency with a predetermined upper limit of issuance set.

13. The information processing method according to claim 9, wherein the computer executes processing of restricting the use of the application or service in stages according to the amount of cryptocurrency held by the user.

14. The information processing method according to claim 9, wherein the computer executes processing of displaying on a user terminal a notification that the cryptocurrency should be purchased when it is determined that the amount held is less than the predetermined number.

15. A non-transitory computer-readable storage medium storing a program causing a computer to execute processing of:
determining whether or not an amount of cryptocurrency held by a user is less than a predetermined number; and
restricting the user's use of an application or service when it is determined that the amount held is less than the predetermined number.

16. An information processing apparatus, comprising:
at least one memory; and
at least one processor configured to execute instructions stored in the memory to:
determine whether or not an amount of cryptocurrency held by a user is less than a predetermined number; and
restrict the user's use of an application or service when it is determined that the amount held is less than the predetermined number.
